(19) United States
(12) Patent Application Publication
(10) Pub. No.: US 2008/0056206 A1
(43) Pub. Date: Mar. 6, 2008

(54) POWER SAVINGS METHOD AND APPARATUS IN A COMMUNICATION SYSTEM

(75) Inventors: David L. Muri, Sunrise, FL (US); John M. De Sabatino, Sunrise, FL (US); Sumit A. Talwalkar, Plantation, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Plantation, FL (US)

(21) Appl. No.: 11/469,120

(22) Filed: Aug. 31, 2006

(51) Int. Cl. H04Q 7/24

(52) U.S. Cl. 370/338

(57) ABSTRACT

A mobile subscriber unit (102) transmits a signal including vocoder voices frames to a base unit (104) within a communication system (100). The base unit (104) repeats the signal including error information from the voice frames to one or more final recipient unit(s). The originating subscriber unit (102) listens to these error mitigated repeated frames and compares the received signal having error information to voice frame conditions, such as calculated, delayed and muted signal patterns. Based on the comparison, the subscriber unit (102) adjusts its power accordingly.

### FIELD OF THE INVENTION

The present invention relates generally to communication systems and more specifically to power saving techniques within such systems.

### BACKGROUND

Radio Frequency (RF) communications systems often incorporate portable communication units, such as battery powered radios and cell phones. Depending on the type of system, portable units may communicate directly with each other or through repeaters, base stations, cell sites or other appropriate infrastructure. Power consumption is always a concern to the portable aspect of such systems in terms of impact to talk time, size and weight of the portable unit. Changes in environmental conditions can cause abrupt variations in signal strength, and the need to compensate for these variations, say by increasing transmit power, becomes important to maintaining consistent communications. Various power control techniques have been utilized to attempt to maintain consistent communications in a power efficient manner. Past power control techniques, however, have often involved changes to the system infrastructure which can be costly and typically involves modifications being made at the infrastructure sites.

Accordingly, it would be beneficial to have an improved power control technique for the portable communication unit of a communication system. A technique that did not require changes in infrastructure or measurements of a received signal would be highly desirable.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of a communication system operating in accordance with the present invention;

FIG. 2 is a block diagram of a portion of the communication system of FIG. 1 in accordance with the present invention;

FIG. 3 shows a more detailed block diagram of FIG. 2 including automatic power adjustment capability in accordance with the present invention; and

FIG. 4 is a flowchart of a method for managing power consumption in a communication system in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in a method and apparatus for managing power consumption in a communication system. Accordingly, the communication system has been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processor” can be defined as any number of suitable processors, controllers, units, or the like that carry out a pre-programmed or programmed set of instructions.

The terms “program,” “software application,” “routine” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In this document, relational terms such as first and second and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

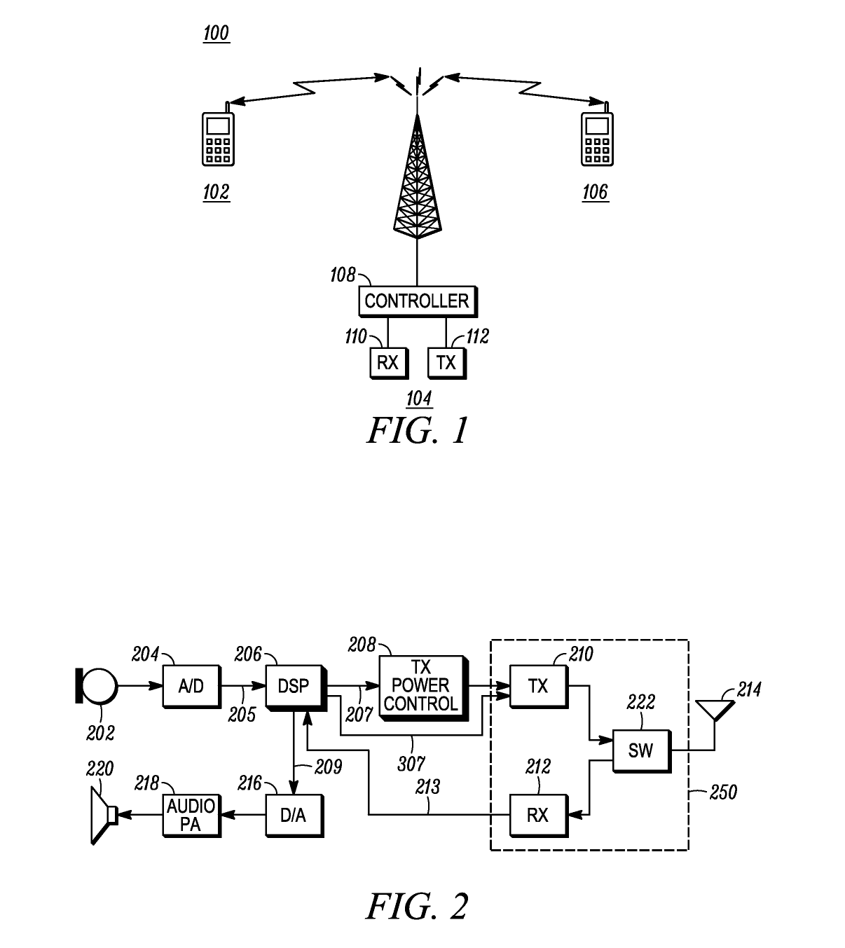

FIG. 1 is a diagram of a communication system 100 formed and operating in accordance with the present invention. Communication system 100 includes mobile subscriber unit 102 and a base unit 104 communicating via radio frequency (RF) signals to one or more additional subscriber units 106. For the purposes of this application, the mobile subscriber unit 102 comprises a battery powered portable communication device, such as a hand-held two-way radio, cell phone or the like. The one or more subscriber units 106 may be hand-held devices or fixed devices. Base station 104 includes a controller section 108, receiver section 110 and transmitter section 112. The communication protocol governing communication system 100 may be full duplex or half duplex as will be described herein. Basic operation of system 100 includes transmitting a signal from subscriber unit 102 to base unit 104, and base unit 104 performing error mitigation on voice frames of the received signal. Base unit 104 then repeats the error mitigated signal to one or more subscriber units 106.

Briefly, in accordance with the present invention, the error mitigated signal generated at base unit 104 is also received back at the originating subscriber unit 102. The originating subscriber unit 102 then performs a comparison of the repeated signal to a plurality of previously calculated and stored voice frames. The result of the comparison determines whether a transmit power control adjustment is made within the subscriber unit 102. By utilizing the repeated signal, the originating subscriber unit 102 is able to adjust itself quickly in response to changes in environmental conditions. Basically, the originating subscriber unit 102 is “eavesdropping” or “listening in” on the error information being relayed to the one or more final intended subscriber units 106.

To further elaborate, the power control of the present invention is accomplished by having the subscriber unit 102 transmit a signal including vocoder voices frames to the base unit 104, and then the base unit 104 repeats the signal, including error information from the voice frames for one or more subscriber units 106, while the original transmitting unit 102 monitors the amount of error mitigation in the repeated signal. The voice frames having error information are also referred to as error mitigated voice frames. In accordance with the present invention, the subscriber unit 102 compares the received error mitigated voice frames to one or more voice frame conditions. These voice frame conditions may include, for example, calculated frames, delayed frames and muted signal patterns. Calculated frames are preferably derived from previous voice transmitted frames. Delayed frames are those frames that were last transmitted and now stored. The muted signal pattern is pre-stored. Based on the comparison of the received error mitigated voice frames to voice frame conditions, the subscriber unit 102 automatically adjusts its transmit power level.

FIG. 2 is a block diagram of the communication system of FIG. 1 which operates in accordance with the automatic power control of the present invention. Subscriber unit 102 generally includes a microphone 202 for receiving an audible voice message to be transmitted. The output of the of the microphone 202 comprises an analog signal representing the voice input, which is passed through to an appropriate analog-to-digital converter 204 which digitizes this information and provides a digital representation of the voice to a digital signal processor (DSP) 206. The DSP 206 produces, as its output, a plurality of discrete packets, wherein each packet contains information representing a portion of the original speech information. These packets are provided via signal path 307 to a transmitter portion 210 of a radio frequency (RF) section 250, which uses the packets to modulate an appropriate carrier signal at antenna 214.

The base unit 104 (of FIG. 1) receives the carrier signal and performs error mitigation on the voice frames using one of several techniques known in the art to generate an error mitigated signal. In accordance with the present invention, the error mitigated signal is repeated to subscriber subscriber(s) 106 and also listened to by originating subscriber 102. The error mitigated signal is received at antenna 214 which is preferably coupled via a switch 222 for switching between the subscriber's transmit path 210 and receive path 212. In response thereto, the DSP 206 generates a digitized signal representing the error mitigated voice frames. In accordance with the present invention, DSP 206 compares the digitized error mitigated voice frames to one or more voice frame conditions. Depending on the condition, a match (or failure to match) results in a transmit power control signal 207 triggering transmit power control 208 to adjust the transmit power level at transmitter 210. Transmit power control 208 may be implemented using bias control of the power amplifier, or other suitable gain control technique known in the art. The subscriber unit 102 further includes a digital-to-analog converter (D/A) 216, an audio amplifier 218 and speaker 220 for regular receive mode operation which is well known in the art and will not be discussed further.

As previously mentioned, the communication protocol governing communication system 100 may be a full duplex or half duplex protocol. For full-duplex operation, both transmit and receive signals can occur on simultaneously. For half-duplex operation, transmit and receive signals occur on alternate time slots. For full-duplex protocols, the repetition of the error mitigated voice frames from the base 104 to the final recipient 106 (also listened to by the originating subscriber unit 102) can occur at any time slot while for half-duplex operation the repetition occurs on alternate time slots. Thus, the power management control of the present invention applies to both full-duplex and half-duplex systems as well as combination systems having half-duplex modes and full-duplex modes of operation.

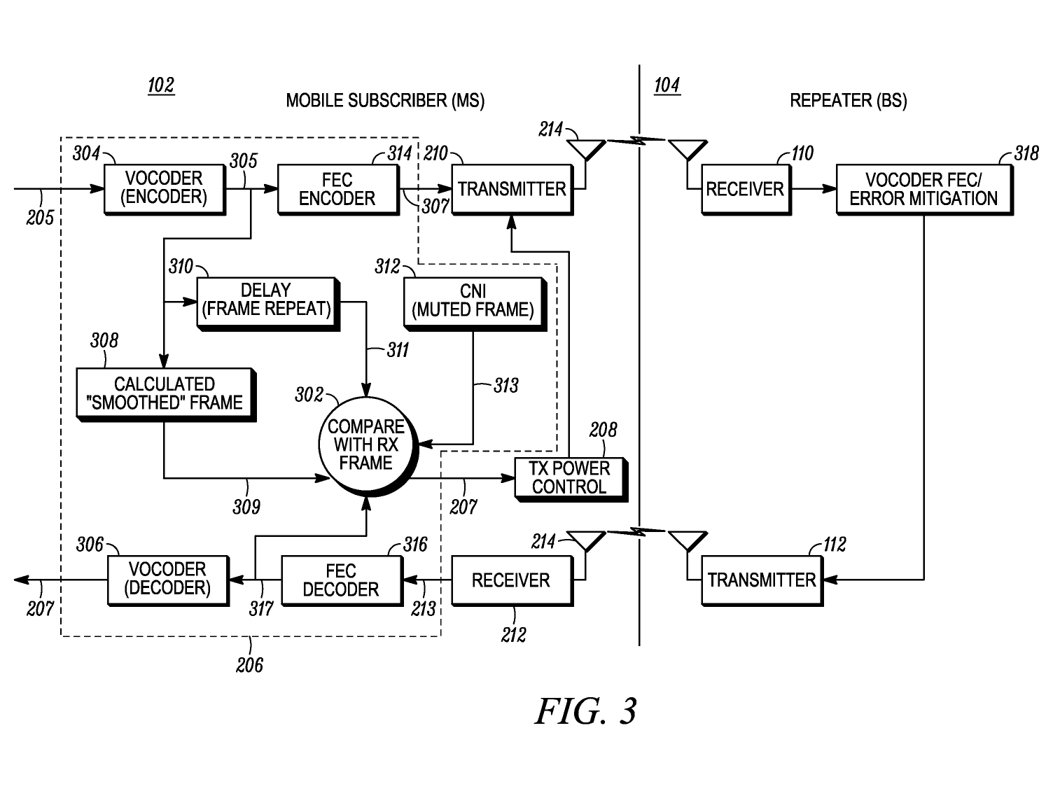

FIG. 3 shows a more detailed block diagram of the automatic power control taking place within the communication system 100 in accordance with the present invention. Subscriber unit 102 includes transmitter 210, receiver 212 along with vocoder/encoder 304 and forward error correction (FEC) encoder 314 for encoding signals in the outgoing transmit path, and vocoder/decoder 306 and FEC decoder 316 for decoding incoming signals in the receive path 212. The base unit 104 includes receiver 110, transmitter 112, controller and a vocoder FEC 318 for determining error rate and performing error mitigation in a manner known in the art.

In accordance with the present invention, subscriber unit 102 generates vocoder voice frames 305 at vocoder 304 and forwards these frames to FEC encoder 314. FEC encoded vocoder voice frames 307 are transmitted via transmitter 210 and antenna 214 to the base unit 104. Base unit 104 receives the incoming RF signal at receiver 110 and determines the error of the FEC vocoder voice frames using vocoder FEC decoding 318 in a manner known in the art. Depending on the error rate, the vocoder voice frames are modified as necessary to provide error mitigated voice frames in a manner consistent with methods known in the art. The error mitigated voice frames are repeated via the base unit's transmitter 112 to the subscriber unit 106. In accordance with the present invention, the subscriber unit 102 also receives the repeated error mitigated voice frames at receiver 212. The error mitigated frames are decoded within DSP 206 utilizing FEC decoder 316. The decoded error mitigated voice frames generated by FEC decoder 316 are compared, using a comparator or the like, 302 to pre-stored and pre-calculated voice frame conditions. For this example the conditions are: the original vocoder encoder frames 305, calculated smoothed frames 309, delayed frames 3 11 and the stored muted frame 313.

The voice frame conditions are pre-calculated and pre-stored patterns that provide references with which to compare at 302 the received repeated error mitigated voice frames 317. In accordance with this embodiment, the voice frame conditions within DSP 206 are generated by taking the output of the vocoder encoder 304 in the transmit path and performing such functions as: calculating a smoothed representation of the frames at 308 and storing previously transmitted frames to create “delayed” frames” at 310. Muted frames, including frames having comfort noise inserted thereon (CNI muted frames), can be stored at 312. In accordance with this embodiment, the FEC decoded signal 317 is compared at 302 to the original vocoder frames 305, calculated frames 309, delayed frames 311 and muted frames 313 to determine whether the frame patterns match. If the comparison at 302 results in a match (or failure to match for some conditions) then a power adjustment is made via transmit power control 208.

If the received error mitigated frame pattern 317 matches delayed frame pattern 311, then no action is taken. If the received error mitigated frame pattern 317 fails to match the delayed frame pattern 311, then transmit power control 208 is increased by a first predetermined level at transmitter 210. If the received error mitigated frame pattern 317 matches the smoothed (calculated) pattern 309, then transmit power control 208 is increased by a second predetermined level at transmitter 210. If the received error mitigated frame 317 matches the muted frame pattern 313, then transmit power is increased by a third predetermined level—this third predetermined level is preferably higher than the first or second power level increases since more power is typically required to overcome the muted condition. At most, only one condition is met for a given frame. The amount of power level increase set for each condition can be determined and adjusted based on system parameters relating to the level of errors in the error mitigated frames.

Again power levels need not be adjusted if the received error mitigated frame 317 matches delayed frame 311, this being an indication that power levels are already appropriately set. Power adjustments need only occur when the error in the repeated error mitigated voice frames indicate that an adjustment is needed. The power level of the adjustment is based on the type of voice frame condition present—the muted condition preferably initiating a higher power increase than the calculated condition.

The power adjustment of the present invention allows for the originating subscriber unit to give itself a “power boost” if it determines there were too many errors in its originally transmitted signal received at base unit 104. The originating subscriber unit 102 is thus able to do a self-assessment based on the error mitigated signal repeated back from the base unit 104. This self-assessment is made without changes to the infrastructure of the system.

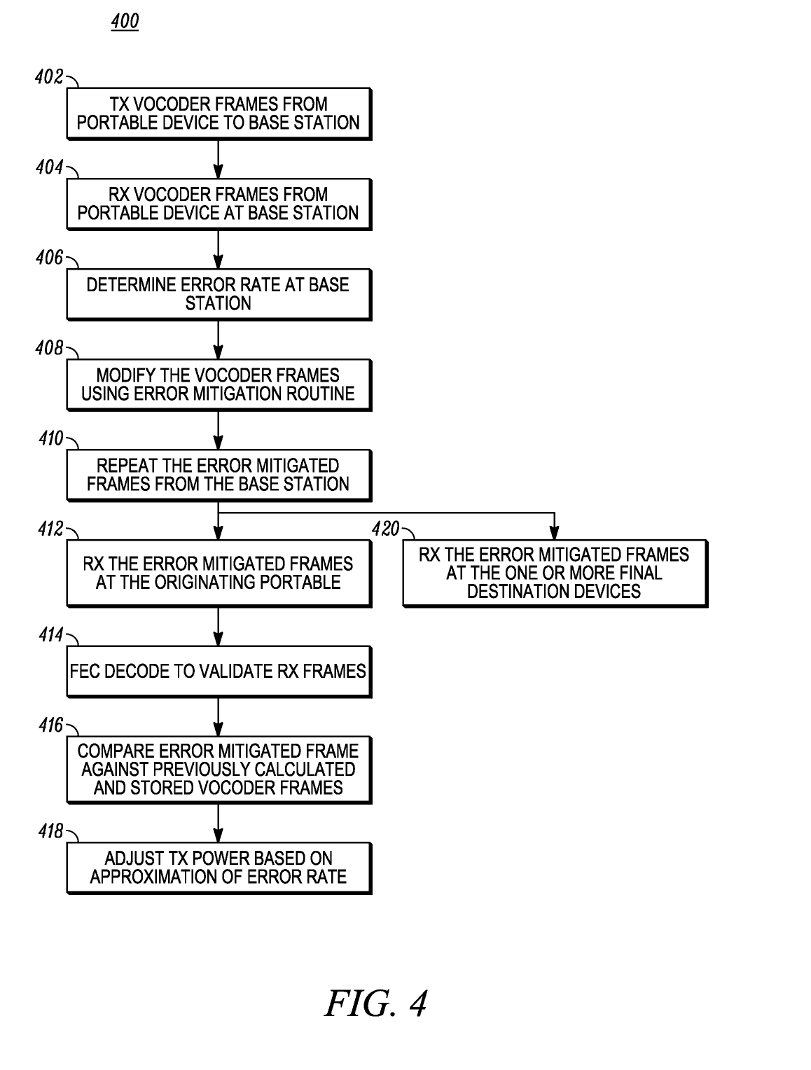

FIG. 4 is a flowchart of a method 400 of managing power control in a communication system in accordance with the present invention. The method begins at 402, by transmitting vocoder voice frames from a portable communication device, such as subscriber unit 102, to a base station, such as base unit 104 of FIG. 1. The base station receives the vocoder voice frames from the portable communication device at 404 and determines the error rate of the frames at 406. The base station then modifies, if needed, the vocoder voice frames within the received signal using an error mitigation routine to provide error mitigated voice frames at 408. These error mitigated voices frames are then repeated from the base station at 410. In accordance with the present invention, the originating portable 412 listens in on the repeated signal and as such, the repeated error mitigated frames are received at the originating portable at 412 and the one or more final destination device at 420.

The error mitigated voice frames received by the originating portable communication device at 412 are FEC decoded at 414 to validate the received frames. This step ensures that only those error mitigated frames from base unit 104 having an acceptably small number of errors are used so that the power adjustment decision is made with a high degree of confidence. The FEC decoded frames are compared to previously calculated and stored vocoder frames at 416, and the portable communication device's transmit power is adjusted, if needed, at step 418 based on the approximation of the error rate as determined by matching or mismatching with the voice frame conditions.

Steps 402-410 and 420 are performed using well established techniques. Step 412-418 provide the portable communication device with the ability to automatically adjust its own power based on an error estimation from repeated vocoder voice frames. The ability of the portable subscriber to automatically adjust its own power based on an error estimation from repeated vocoder voice frames allows for an automatic power control technique that provides effective power control at the portable subscriber without changing the system infrastructure. Imperfect signal quality predictions at the base station or rapid changes in signal conditions can now be quickly overcome. Because an incorrect power level can be quickly corrected, a greater difference in the minimum to maximum power can be used which allows more power levels to be included within the subscriber. By increasing the number of available power levels, the battery life of the portable subscriber is increased. Furthermore, the use of estimation for the received error rate is significant in that the outbound bandwidth need not be increased. In other words, no “extra” information is needed in the reverse channel.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A communication system, including:
a plurality of subscriber units including an originating subscriber unit transmitting a signal;
a base unit receiving the signal and generating an error mitigated voice frame signal, the base unit repeating the error mitigated voice frame signal; and
the originating subscriber unit listening to the repeated error mitigated voice frame signal and selectively performing a power adjustment in response thereto.

2. A communication system, comprising:
an originating subscriber unit transmitting a signal;
a base unit;
one or more additional subscriber units; and
the base unit receiving the signal from the originating subscriber unit, performing error mitigation on the signal and repeating an error mitigated signal; and
the originating subscriber unit and the one or more additional subscriber units receiving the repeated error mitigated signal, the originating subscriber unit determining a transmit power adjustment in response thereto.

3. The communication system of claim 2, wherein the originating subscriber unit includes a digital signal processor (DSP) for determining whether to perform the power adjustment.

4. The communication system of claim 2, wherein the error mitigated signal includes error mitigated voice frames and the originating subscriber unit includes a digital signal processor (DSP) for performing a comparison of the error mitigated voice frames to previously calculated and stored voice frames.

5. The communication system of claim 4, wherein the DSP generates the calculated voice frames from previously transmitted signals of the originating subscriber unit.

6. A method of managing power control in a communication system, comprising:
transmitting a signal from a portable communication device to a base unit;
repeating error mitigated voice frames from the base unit;
receiving the repeated error migrated voice frames at the portable communication device and at least one other final destination device; and
adjusting transmit power at the portable communication device based on the repeated error mitigated voice frames.

7. The method of claim 6, wherein the step of adjusting further includes the step of comparing the repeated error mitigated voice frames to a plurality of voice frame conditions within the portable communication device.

8. A method of managing power consumption in a communication system, comprising:
transmitting vocoder voice frames from a portable communication device;
receiving the vocoder voice frames at a base station;
determining an error rate of the received vocoder voice frames at the base station;
modifying the vocoder voice frames using an error mitigation routine to provide error mitigated voice frames;
repeating the error mitigated voice frames from the base station;
receiving the error mitigated voice frames at a final destination communication device and the portable communication device; and
adjusting transmit power at the portable communication device based on error mitigated voice frames.

9. The method of claim 8, wherein the step of receiving the error mitigated voice frames at the portable communication device further includes applying forward error correction (FEC) decoding to the error mitigated voice frames to validate the received frames.

10. The method of claim 8, wherein the step of adjusting transmit power at the portable communication device includes comparing the error mitigated voice frames against previously calculated and stored vocoder frames within the portable communication device.

11. The method of claim 10, wherein the previously calculated and stored vocoder frames are generated by:
adaptive smoothing of transmitted vocoder voice frame patterns;
delaying transmitted voice frame patterns; and
storing muted voice frame patterns.

12. A communication system, comprising:
a portable communication device transmitting voice frames;
a base station receiving the transmitted voice frames and repeating error mitigated voice frames to be received by final destination devices, the portable communication device listening to the repeated error mitigated voice frames; and
the portable communication device automatically adjusting its transmit power based on the error mitigated voice frames.

13. The communication system of claim 12, wherein the error mitigated voice frames are compared to a plurality of voice frame conditions within the portable communication device.

14. The communication device of claim 13, wherein the comparison determines the level of power adjustment of the portable communication device.

15. The communication device of claim 14, wherein the voice frame conditions include at least one of a calculated frame, a delayed frame and a muted frame.

16. The communication system of claim 15, wherein the plurality of voice frame conditions are generated by applying an encoded signal from a transmit path of the portable communication device to a smoothing calculation and a delay, the muted frame being pre-stored.

17. The communication system of claim 12, wherein the communication system comprises a half-duplex system.

18. The communication system of claim 12, wherein the communication system comprises a full-duplex system.
